(19) United States
(12) Patent Application Publication
(10) Pub. No.: US 2016/0072651 A1
(43) Pub. Date: Mar. 10, 2016

(54) METHOD AND SYSTEM FOR A MULTI-LEVEL ENCODED DATA PATH WITH DECODER

(71) Applicant: Luxtera, Inc., Carlsbad, CA (US)

(72) Inventor: Brian Welch, San Diego, CA (US)

(21) Appl. No.: 14/845,961

(22) Filed: Sep. 4, 2015

Related U.S. Application Data
(60) Provisional application No. 62/070,742, filed on Sep. 4, 2014.

(51) Int. Cl. H04L 25/49; H04L 27/20

(52) U.S. Cl. CPC H04L 25/4917; H04L 27/2071; H04L 25/4906

(57) ABSTRACT

Methods and systems for a multi-level encoded data path with decoder are disclosed and may include, in a receiver on a chip: receiving a multi-level encoded signal, generating a plurality of copy signals offset from the multi-level encoded signal by a configurable offset voltage, comparing each copy signal against a different threshold level, and generating binary data based on the comparison. At least one of the plurality of copy signals may be compared using a clock data recovery module and/or using a retimer, which may comprise at least one D flip-flop. The multi-level encoded signal may comprise a pulse amplitude modulated-4 (PAM-4) signal. The multi-level encoded signal may be received from a photodiode on the chip. An optical signal may be communicated to the photodiode from a grating coupler on the chip.

### CROSS-REFERENCE TO RELATED APPLICATIONS/INCORPORATION BY REFERENCE

This application claims priority to and the benefit of U.S. Provisional Application 62/070,742 filed on Sep. 4, 2014, which is hereby incorporated herein by reference in its entirety.

### FIELD

Certain embodiments of the disclosure relate to semiconductor photonics. More specifically, certain embodiments of the disclosure relate to a method and system for a multi-level encoded data path with decoder.

### BACKGROUND

As data networks scale to meet ever-increasing bandwidth requirements, the shortcomings of copper data channels are becoming apparent. Signal attenuation and crosstalk due to radiated electromagnetic energy are the main impediments encountered by designers of such systems. They can be mitigated to some extent with equalization, coding, and shielding, but these techniques require considerable power, complexity, and cable bulk penalties while offering only modest improvements in reach and very limited scalability. Free of such channel limitations, optical communication has been recognized as the successor to copper links.

Further limitations and disadvantages of conventional and traditional approaches will become apparent to one of skill in the art, through comparison of such systems with the present disclosure as set forth in the remainder of the present application with reference to the drawings.

### BRIEF SUMMARY

A system and/or method for a multi-level encoded data path with decoder, substantially as shown in and/or described in connection with at least one of the figures, as set forth more completely in the claims.

Various advantages, aspects and novel features of the present disclosure, as well as details of an illustrated embodiment thereof, will be more fully understood from the following description and drawings.

### BRIEF DESCRIPTION OF SEVERAL VIEWS OF THE DRAWINGS

FIG. 1A is a block diagram of a photonically-enabled integrated circuit with a multi-level encoded data path with decoder, in accordance with an example embodiment of the disclosure.

FIG. 1B is a diagram illustrating an exemplary photonically-enabled integrated circuit, in accordance with an exemplary embodiment of the disclosure.

FIG. 1C is a diagram illustrating a photonically-enabled integrated circuit coupled to an optical fiber cable, in accordance with an example embodiment of the disclosure.

FIG. 2 illustrates a multi-level encoded data receiver, in accordance with an example embodiment of the disclosure.

FIG. 3 illustrates a circuit schematic of an example level shifter, in accordance with an example embodiment of the disclosure.

FIG. 4 illustrates a circuit schematic of an example selector, in accordance with an example embodiment of the disclosure.

### DETAILED DESCRIPTION

Certain aspects of the disclosure may be found in a method and system for a pulse amplitude modulation data path with decoder. Exemplary aspects of the disclosure may comprise in a receiver on a chip: receiving a multi-level encoded signal, generating a plurality of copy signals offset from the multi-level encoded signal by a configurable offset voltage, comparing each copy signal against a different threshold level, and generating binary data based on the comparison of each copy signal. At least one of the plurality of copy signals may be compared using a clock data recovery module and/or using a retimer. The retimer may comprise at least one D flip-flop. The multi-level encoded signal may comprise a pulse amplitude modulated (PAM) signal. The PAM signal may comprise a PAM-4 signal. The multi-level encoded signal may be received from a photodiode on the chip. An optical signal may be communicated to the photodiode from a grating coupler on the chip. Offset voltages may be generated for the plurality of copy signals using a level shifter comprising parallel transistor/resistor current mirror branches. The semiconductor die may comprise a silicon complementary-metal oxide semiconductor (CMOS) photonics die.

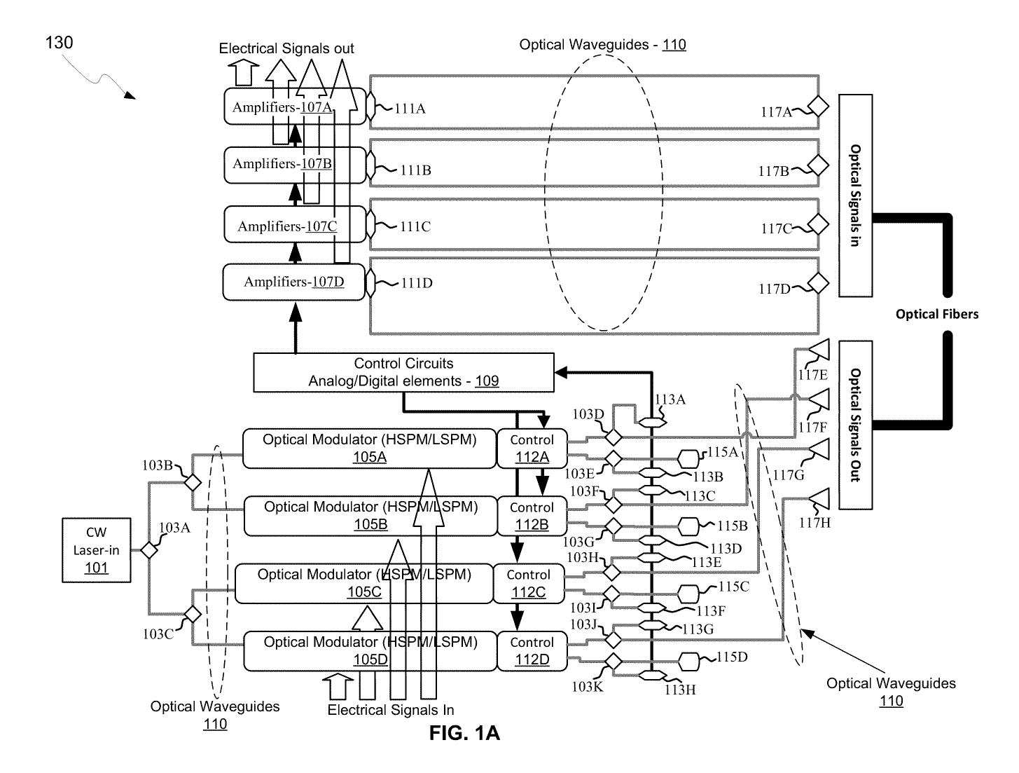

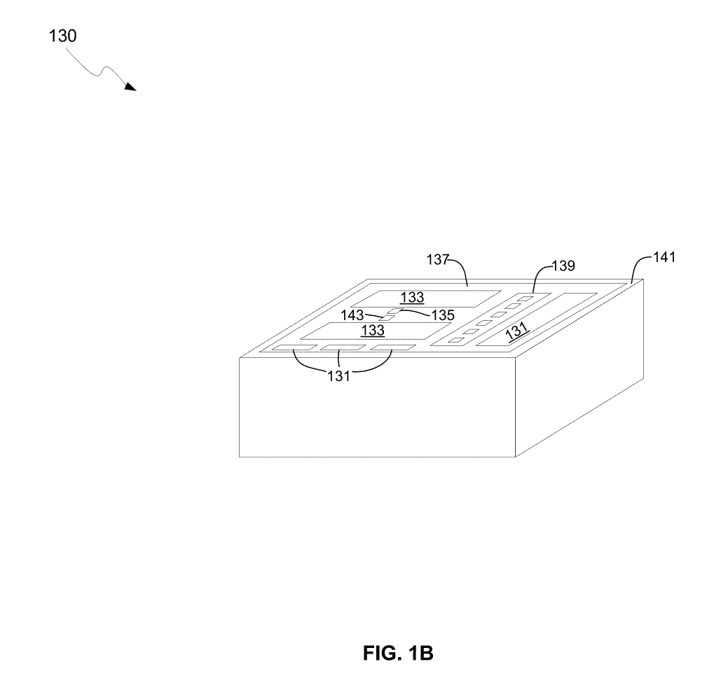

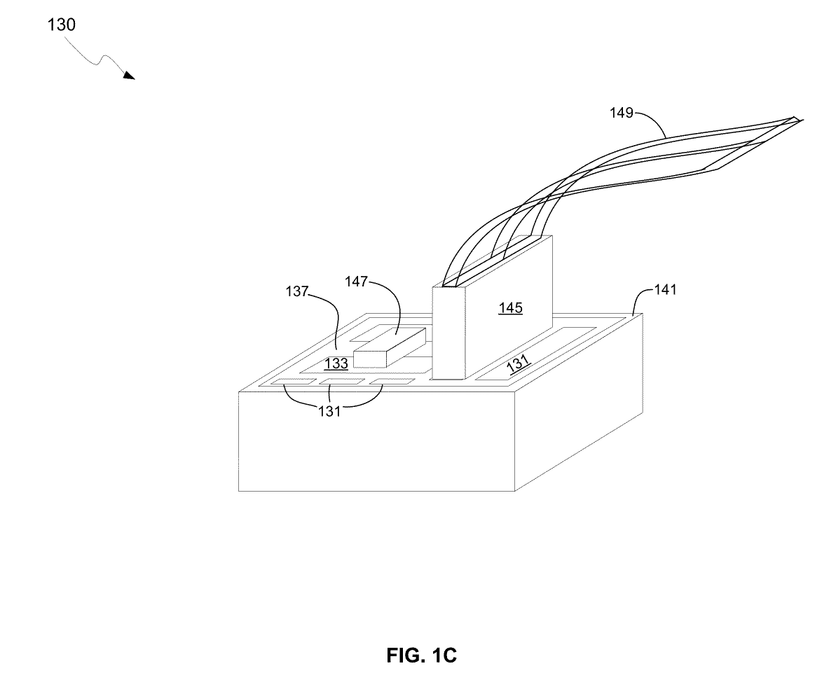

FIG. 1A is a block diagram of a photonically-enabled integrated circuit with a multi-level encoded data path with decoder, in accordance with an example embodiment of the disclosure. Referring to FIG. 1A, there are shown optoelectronic devices on a photonically-enabled integrated circuit 130 comprising optical modulators 105A-105D, photodiodes 111A-111D, monitor photodiodes 113A-113H, and optical devices comprising couplers 103A-103K, optical terminations 115A-115D, and grating couplers 117A-117H. There are also shown electrical devices and circuits comprising amplifiers 107A-107D, analog and digital control circuits 109, and control sections 112A-112D. The amplifiers 107A-107D may comprise transimpedance and limiting amplifiers (TIA/LAs), for example.

In an example scenario, the photonically-enabled integrated circuit 130 comprises a CMOS photonics die with a laser assembly 101 coupled to the top surface of the IC 130. The laser assembly 101 may comprise one or more semiconductor lasers with isolators, lenses, and/or rotators for directing one or more CW optical signals to the coupler 103A.

Optical signals are communicated between optical and optoelectronic devices via optical waveguides 110 fabricated in the photonically-enabled integrated circuit 130. Single-mode or multi-mode waveguides may be used in photonic integrated circuits. Single-mode operation enables direct connection to optical signal processing and networking elements. The term “single-mode” may be used for waveguides that support a single mode for each of the two polarizations, for example transverse-electric (TE) and transverse-magnetic (TM), or for waveguides that are truly single mode and only support one mode whose polarization is, for example, TE, which comprises an electric field parallel to the substrate supporting the waveguides. Two typical waveguide cross-sections that are utilized comprise strip waveguides and rib waveguides. Strip waveguides typically comprise a rectangular cross-section, whereas rib waveguides comprise a rib section on top of a waveguide slab. Of course, other waveguide cross section types are also contemplated and within the scope of the disclosure.

In an example scenario, the couplers 103A-103C may comprise low-loss Y-junction power splitters where coupler 103A receives an optical signal from the laser assembly 101 and splits the signal to two branches that direct the optical signals to the couplers 103B and 103C, which split the optical signal once more, resulting in four roughly equal power optical signals.

The optical modulators 105A-105D comprise Mach-Zehnder or ring modulators, for example, and enable the modulation of the continuous-wave (CW) laser input signal. The optical modulators 105A-105D may comprise high-speed and low-speed phase modulation sections and are controlled by the control sections 112A-112D. The high-speed phase modulation section of the optical modulators 105A-105D may modulate a CW light source signal with a data signal. The low-speed phase modulation section of the optical modulators 105A-105D may compensate for slowly varying phase factors such as those induced by mismatch between the waveguides, waveguide temperature, or waveguide stress and is referred to as the passive phase, or the passive biasing of the MZI.

The outputs of the optical modulators 105A-105D may be optically coupled via the waveguides 110 to the grating couplers 117E-117H. The couplers 103D-103K may comprise four-port optical couplers, for example, and may be utilized to sample or split the optical signals generated by the optical modulators 105A-105D, with the sampled signals being measured by the monitor photodiodes 113A-113H. The unused branches of the directional couplers 103D-103K may be terminated by optical terminations 115A-115D to avoid back reflections of unwanted signals.

The grating couplers 117A-117H comprise optical gratings that enable coupling of light into and out of the photonically-enabled integrated circuit 130. The grating couplers 117A-117D may be utilized to couple light received from optical fibers into the photonically-enabled integrated circuit 130, and the grating couplers 117E-117H may be utilized to couple light from the photonically-enabled integrated circuit 130 into optical fibers. The grating couplers 117A-117H may comprise single polarization grating couplers (SPGC) and/or polarization splitting grating couplers (PSGC). In instances where a PSGC is utilized, two input, or output, waveguides may be utilized.

The optical fibers may be epoxied, for example, to the CMOS chip, and may be aligned at an angle from normal to the surface of the photonically-enabled integrated circuit 130 to optimize coupling efficiency. In an example embodiment, the optical fibers may comprise single-mode fiber (SMF) and/or polarization-maintaining fiber (PMF).

In another exemplary embodiment illustrated in FIG. 1B, optical signals may be communicated directly into the surface of the photonically-enabled integrated circuit 130 without optical fibers by directing a light source on an optical coupling device in the chip, such as the light source interface 135 and/or the optical fiber interface 139. This may be accomplished with directed laser sources and/or optical sources on another chip flip-chip bonded to the photonically-enabled integrated circuit 130.

The photodiodes 111A-111D may convert optical signals received from the grating couplers 117A-117D into electrical signals that are communicated to the amplifiers 107A-107D for processing. In another exemplary embodiment of the disclosure, the photodiodes 111A-111D may comprise high-speed heterojunction phototransistors, for example, and may comprise germanium (Ge) in the collector and base regions for absorption in the 1.3-1.6 μm optical wavelength range, and may be integrated on a CMOS silicon-on-insulator (SOI) wafer.

The analog and digital control circuits 109 may control gain levels or other parameters in the operation of the amplifiers 107A-107D, which may then communicate electrical signals off the photonically-enabled integrated circuit 130. The control sections 112A-112D comprise electronic circuitry that enable modulation of the CW laser signal received from the splitters 103A-103C. The optical modulators 105A-105D may require high-speed electrical signals to modulate the refractive index in respective branches of a Mach-Zehnder interferometer (MZI), for example. In an example embodiment, the control sections 112A-112D may include sink and/or source driver electronics that may enable a bidirectional link utilizing a single laser.

In operation, the photonically-enabled integrated circuit 130 may be operable to transmit and/or receive and process optical signals. Optical signals may be received from optical fibers by the grating couplers 117A-117D and converted to electrical signals by the photodetectors 111A-111D. The electrical signals may be amplified by transimpedance amplifiers in the amplifiers 107A-107D, for example, and subsequently communicated to other electronic circuitry, not shown, in the photonically-enabled integrated circuit 130.

The amplifiers 107A-107D and associated control circuits 109 may be operable to receive and decode multi-level encoded signals. In an example scenario, pulse amplitude modulated (PAM), e.g., PAM4, signals may be received and decoded. Offset copies of the PAM4 signal may be generated to center separate levels around zero, nominally the decision threshold. Redundant parallel branches with a shared clock may “clean up” the signal utilizing limiting amplifiers or clock data recovery (CDR) modules, for example, to create “thermometer” coded data. Signals passed through a limiting amplifier may compress eye patterns not of interest. The CDR may share elements across different codes/paths, such as a voltage controlled oscillator (VCO) and/or phase locked loop (PLL). The thermometer data may be converted to binary using a CML selector, for example, which at lower rates of operation may be performed without the CDR process, e.g., where the jitter margin is acceptable.

FIG. 1B is a diagram illustrating an exemplary photonically-enabled integrated circuit, in accordance with an exemplary embodiment of the disclosure. Referring to FIG. 1B, there is shown the photonically-enabled integrated circuit 130 comprising electronic devices/circuits 131, optical and optoelectronic devices 133, a light source interface 135, a chip front surface 137, an optical fiber interface 139, CMOS guard ring 141, and a surface-illuminated monitor photodiode 143.

The light source interface 135 and the optical fiber interface 139 comprise grating couplers, for example, that enable coupling of light signals via the CMOS chip surface 137, as opposed to the edges of the chip as with conventional edge-emitting/receiving devices. Coupling light signals via the chip surface 137 enables the use of the CMOS guard ring 141 which protects the chip mechanically and prevents the entry of contaminants via the chip edge.

The electronic devices/circuits 131 comprise circuitry such as the amplifiers 107A-107D and the analog and digital control circuits 109 described with respect to FIG. 1A, for example. The optical and optoelectronic devices 133 comprise devices such as the couplers 103A-103K, optical terminations 115A-115D, grating couplers 117A-117H, optical modulators 105A-105D, high-speed heterojunction photodiodes 111A-111D, and monitor photodiodes 113A-113I.

In an example scenario, the optical and electronic devices are operable to receive multi-level encoded signals, which may then be offset resulting in three redundant paths with different signal offsets. Limiting amplifiers and/or CDRs in the parallel paths may generate thermometer coded data that may then be converted to binary data using a CML selector, for example.

FIG. 1C is a diagram illustrating a photonically-enabled integrated circuit coupled to an optical fiber cable, in accordance with an example embodiment of the disclosure. Referring to FIG. 1C, there is shown the photonically-enabled integrated circuit 130 comprising the chip surface 137, and the CMOS guard ring 141. There is also shown a fiber-to-chip coupler 145, an optical fiber cable 149, and an optical source assembly 147.

The photonically-enabled integrated circuit 130 comprising the electronic devices/circuits 131, the optical and optoelectronic devices 133, the light source interface 135, the chip surface 137, and the CMOS guard ring 141 may be as described with respect to FIG. 1B, for example.

In an example embodiment, the optical fiber cable may be affixed, via epoxy for example, to the CMOS chip surface 137. The fiber chip coupler 145 enables the physical coupling of the optical fiber cable 149 to the photonically-enabled integrated circuit 130.

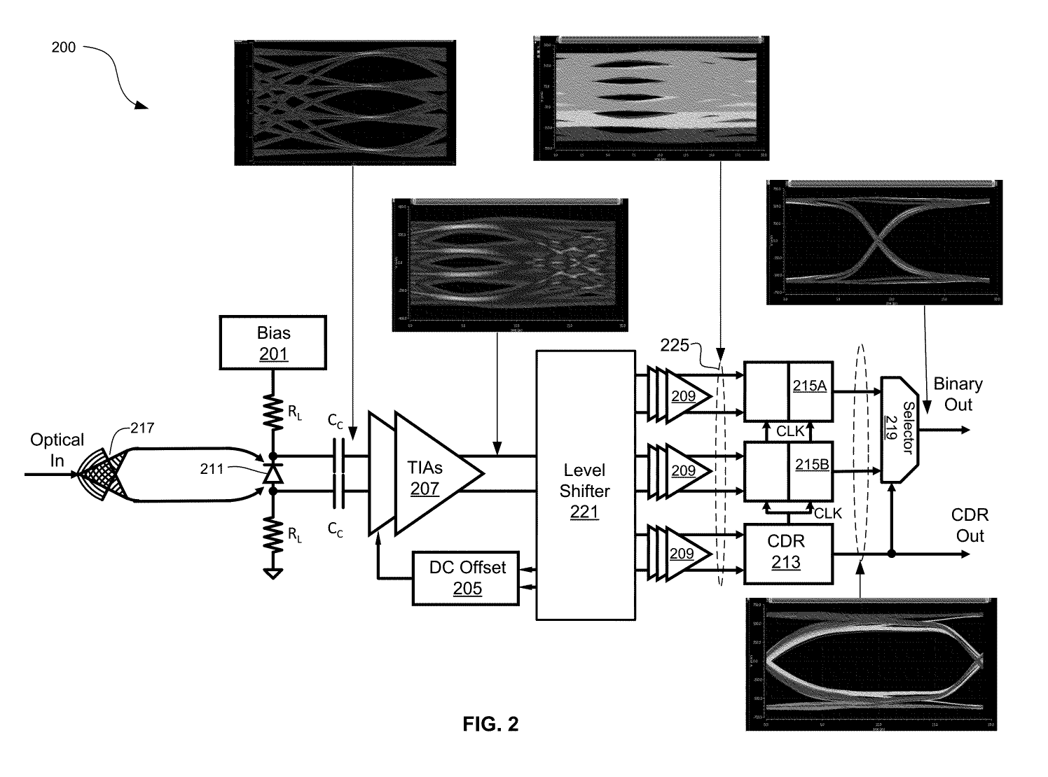

FIG. 2 illustrates a multi-level encoded data receiver, in accordance with an example embodiment of the disclosure. Referring to FIG. 2, there is shown receiver path 200 comprising an input grating coupler 217, photodiode 211, photodiode bias control module 201, bias resistors R_{L}, coupling capacitors C_{C}, transimpedance amplifiers (TIAs) 207, limiting amplifiers 209, CDR 213, retimers 215A and 215B, DC offset module 205, selector 219, and level shifter 221. The insets show example signal eye patterns at various points in the receiver path 200.

The grating coupler 217 may comprise a polarization splitting grating couple that is operable to receive optical signals at different polarizations and communicate the received signals to the photodiode 211 via optical waveguides, for example. The photodiode 211 may comprise silicon, silicon germanium, or other suitable semiconductor material for receiving optical signals of a desired wavelength and generating an output electrical signal.

The bias control module 201 and bias resistors R_{L} may configure the bias current and voltage of the photodiode 211 for desired performance. The electrical signal generated by the photodiode 211 in response to a received optical signal may be AC coupled to the TIAs 207 via the coupling capacitors C_{C}. An eye pattern is shown for the signal input the TIAs 207, which may amplify the signal, resulting in a slightly less sharp eye pattern as shown in the second inset.

The level shifter 221 may comprise suitable circuity, logic, and/or code for generating multiple versions of the input signal but offset by a configurable amount. In an example scenario, each side of the differential input may comprise three gate connected source followers, each of which create a copy of the input signal at a different output level (DC). In an example scenario, the level shifters may shift the input signal +⅓ A, 0 V, and −⅓ A, where A is the signal amplitude.

Then signals may be selected from the 6 unique outputs, unique in a DC sense, but from an AC perspective there are still two copies of the original input signal, to create differential signals with the appropriate offset. In this manner, the eye of interest, the actual output to be determined, may be centered around 0V differential in one of the three output paths.

While three differential outputs are shown, this is merely an example for PAM 4 signals, and may have different numbers of outputs for different encoding schemes. Furthermore, while a differential input and outputs are shown, single-ended inputs and outputs are also possible.

The limiting amplifiers 209 may provide compression of the magnitude of a signal by generating a limited output swing independent of the maximum input voltage above a threshold, and may be used to remove the unwanted eyes from any particular lane/path in the receiver 200. The multiple signals at the outputs of the limiting amplifiers 209 are shown in the eye patterns of the third inset of FIG. 2 indicated by the arrow at the outputs of the limiting amplifiers 209. The inset shows an overlay of the three parallel lanes. Assuming the PAM4 signal has the following lane ordering (top to bottom); 00/01/10/11 then the sampler for the bottom eye captures the 01/11 states, the middle eye the 01/10 states, and the top eye the 00/01 states.

The CDR 213 may comprise suitable circuity, logic, and/or code for generating a clock signal from the received signal and may provide a common clock for the retimers 215A and 215B. In addition the CDR 213 may generate a thermometer coded signal. The retimers 215A and 215B may comprise a pair of D flip-flops, for example, that may be operable to remove the unwanted eyes from a particular path/branch, as each branch is to deal with one of the three eyes, and to clean up any jitter in the signal.

Once any particular eye is centered around zero, the other eyes can be removed either by the limiting amplifier, which compresses the outer eyes, or a latch/flip-flop, the basis of the retimers 215A and 215B. The retimers 215A and 215B sample data above/below zero and do not discern if there are multiple states above or below. Eye patterns thermometer data signals at the outputs of the CDR 213 and retimers 215A and 215B are shown in the bottom inset of FIG. 2.

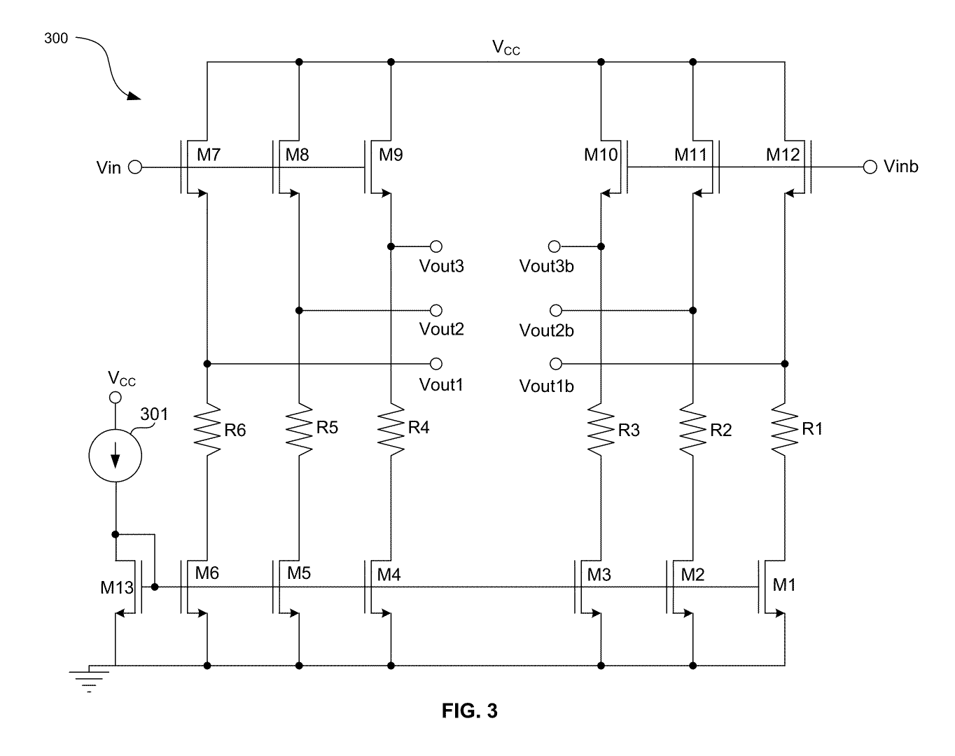

The selector 219 may comprise suitable circuitry, logic, and/or code for generating a binary output from the received thermometer code. Each branch of the receiver is measuring to decide if the data is above or below a certain level, and only discerns between two valid states (as opposed to four). So to make sure all the data is captured, different thresholds are generated against which the CDR 213 and retimers 215A and 215B measure “above or below”. Based on that data and the three streams, the two bits are subsequently recreated by the selector 219. [The selector 219 functions similarly to a multiplexer, and an example schematic is shown in FIG. 3.

FIG. 3 illustrates a circuit schematic of an example level shifter, in accordance with an example embodiment of the disclosure. Referring to FIG. 3, there is shown level shifter 300 comprising transistors M1-M13, resistors R1-R6, and current source 301. There are also shown a differential input Vin-Vinb, and differential outputs Vout1-vout1b, vout2-vout2b, and vout3-vout3b. In an example scenario, the transistors M1-M13 comprise silicon N-channel CMOS transistors, although the disclosure is not so limited.

The current source 301 may comprise circuitry that is operable to provide a configurable constant current to the diode-connected transistor M13, which in parallel with the transistors M1-M6 comprises a current mirror providing current to each of the output branches through the resistors R1-R6. By configuring the transistors to different sizes, e.g, L/W ratios, the current through each resistor is different, and each output generates the same signal in AC, but offset by a DC voltage.

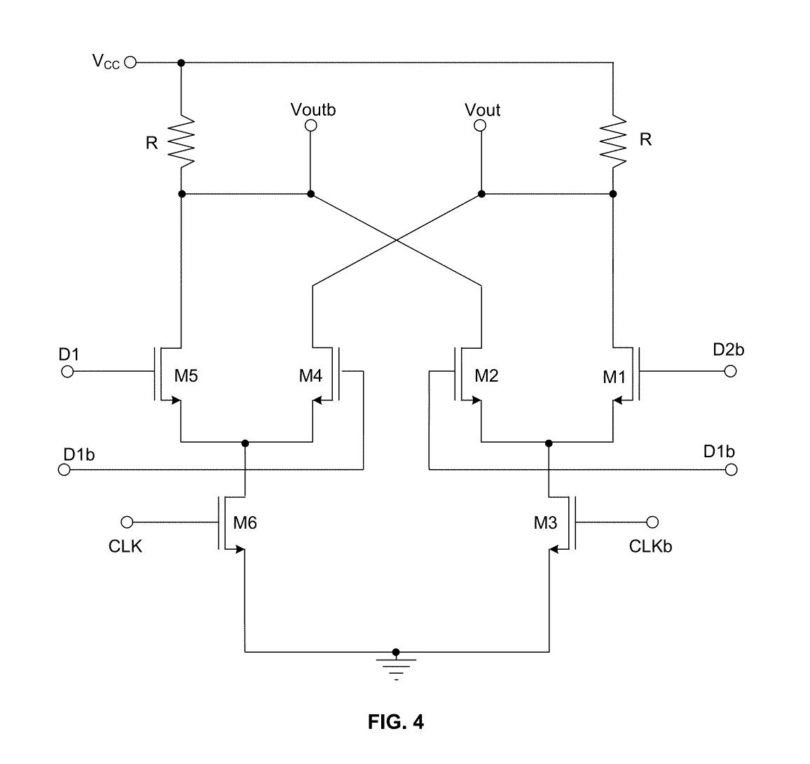

FIG. 4 illustrates a circuit schematic of an example selector, in accordance with an example embodiment of the disclosure. Referring to FIG. 4 there is shown selector 400 comprising transistors M1-M5 and resistors R. There are also shown differential inputs D1-D1b, D2-D2b, and CLK-CLKb, and a differential output Vout-voutb. In an example scenario, the transistors M1-M6 comprise silicon N-channel CMOS transistors, although the disclosure is not so limited.

In an example scenario, thermometer coded data, such as from the retimers 215A/215B and the CDR 213, may be communicated to the differential inputs D1-D1b, D2-D2b and CLK inputs, respectively. The selector 300 may be triggered by one of the data streams, e.g., the center eye, which captures the MSB, and then selects the appropriate input to reconstruct the LSB. The center part of the eye captures the MSB, so the selector 400 may resolve the LSB from that point, which is stored in the LSB. By triggering off the MSB, the selector 400 basically determines which of the other lanes to capture LSB data from.

Therefore, the receiver 200 with level shifter 300 and selector 400 comprises a multi-level sampler where the sampling is accomplished by first creating shifted copies of a signal and then sampling them in parallel with a sampling circuit. The example selector 400 is more specific to a PAM4 implementation.

In an example embodiment, a method and system are disclosed for a multi-level encoded data path with decoder. In this regard, aspects of the disclosure may comprise a receiver on a chip, where the receiver is operable to receive a multi-level encoded signal, generate a plurality of copy signals offset from the multi-level encoded signal by a configurable offset voltage, compare each copy signal against a different threshold level, and generate binary data based on the comparison of each copy signal. At least one of the plurality of copy signals may be compared using a clock data recovery module, and/or using a retimer.

The retimer may comprise at least one D flip-flop. The multi-level encoded signal may comprise a pulse amplitude modulated (PAM) signal. The PAM signal may comprise a PAM-4 signal. The multi-level encoded signal may be received from a photodiode on the chip. An optical signal may be communicated to the photodiode from a grating coupler on the chip. Offset voltages may be generated for the plurality of copy signals using a level shifter comprising parallel transistor/resistor current mirror branches. The semiconductor die may comprise a silicon complementary-metal oxide semiconductor (CMOS) photonics die.

As utilized herein the terms “circuits” and “circuitry” refer to physical electronic components (i.e. hardware) and any software and/or firmware (“code”) which may configure the hardware, be executed by the hardware, and or otherwise be associated with the hardware. As used herein, for example, a particular processor and memory may comprise a first “circuit” when executing a first one or more lines of code and may comprise a second “circuit” when executing a second one or more lines of code. As utilized herein, “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”. As utilized herein, the term “exemplary” means serving as a non-limiting example, instance, or illustration. As utilized herein, the terms “e.g.,” and “for example” set off lists of one or more non-limiting examples, instances, or illustrations. As utilized herein, circuitry is “operable” to perform a function whenever the circuitry comprises the necessary hardware and code (if any is necessary) to perform the function, regardless of whether performance of the function is disabled or not enabled (e.g., by a user-configurable setting, factory trim, etc.).

While the disclosure has been described with reference to certain embodiments, it will be understood by those skilled in the art that various changes may be made and equivalents may be substituted without departing from the scope of the present disclosure. In addition, many modifications may be made to adapt a particular situation or material to the teachings of the present disclosure without departing from its scope. Therefore, it is intended that the present disclosure not be limited to the particular embodiments disclosed, but that the present disclosure will include all embodiments falling within the scope of the appended claims.

What is claimed is:

1. A method for communication, the method comprising:
in a receiver on a chip:
receiving a multi-level encoded signal;
generating a plurality of copy signals offset from the multi-level encoded signal by a configurable offset voltage;
comparing each copy signal against a different threshold level; and
generating binary data based on the comparing of each copy signal.

2. The method according to claim 1, comprising comparing at least one of the plurality of copy signals using a clock data recovery module.

3. The method according to claim 1, comprising comparing at least one of the plurality of copy signals using a retimer.

4. The method according to claim 3, wherein the retimer comprises at least one D flip-flop.

5. The method according to claim 1, wherein the multi-level encoded signal comprises a pulse amplitude modulated (PAM) signal.

6. The method according to claim 5, wherein the PAM signal comprises a PAM-4 signal.

7. The method according to claim 1, comprising receiving the multi-level encoded signal from a photodiode on the chip.

8. The method according to claim 8, comprising communicating an optical signal to the photodiode from a grating coupler on the chip.

9. The method according to claim 1, comprising generating offset voltages for said plurality of copy signals using a level shifter comprising parallel transistor/resistor current mirror branches.

10. The method according to claim 1, wherein the semiconductor die comprises a silicon complementary-metal oxide semiconductor (CMOS) photonics die.

11. A system for communication, the system comprising:
a receiver on a chip, the receiver being operable to:
receive a multi-level encoded signal;
generate a plurality of copy signals offset from the multi-level encoded signal by a configurable offset voltage;
compare each copy signal against a different threshold level; and
generate binary data based on the comparing of each copy signal.

12. The system according to claim 11, wherein the receiver is operable to compare at least one of the plurality of copy signals using a clock data recovery module.

13. The system according to claim 11, wherein the receiver is operable to compare at least one of the plurality of copy signals using a retimer.

14. The system according to claim 13, wherein the retimer comprises at least one D flip-flop.

15. The system according to claim 11, wherein the multi-level encoded signal comprises a pulse amplitude modulated (PAM) signal.

16. The system according to claim 15, wherein the PAM signal comprises a PAM-4 signal.

17. The system according to claim 11, wherein the receiver is operable to receive the multi-level encoded signal from a photodiode on the chip.

18. The system according to claim 11, wherein the receiver is operable to communicate an optical signal to the photodiode from a grating coupler on the chip.

19. The system according to claim 11, wherein the receiver is operable to generate offset voltages for said plurality of copy signals using a level shifter comprising parallel transistor/resistor current mirror branches.

20. A system for communication, the system comprising:
a receiver on a chip, the receiver being operable to:
receive a pulse amplitude modulated-4 (PAM-4) encoded signal;
generate two copy signals offset from the multi-level encoded signal by a configurable offset voltage;
compare each copy signal against a different threshold level; and
generate binary data based on the comparing of each copy signal.
